(19) United States
(12) Patent Application Publication
(10) Pub. No.: US 2010/0300563 A1
(43) Pub. Date: Dec. 2, 2010

(54) Modular device and method for moving fluids to and from a sample delivery element

(76) Inventors: John Ramunas, Stanford, CA (US); Juan G. Santiago, Stanford, CA (US); Helen M. Blau, Menlo Park, CA (US); Keith T. Wong, Vancouver, WA (US); Viktor Shkolnikov, Chatsworth, CA (US); Karl Stahl, Menlo Park, CA (US); Khaesha Hall, Stanford, CA (US); Kevin Nam Truong, Monterey Park, CA (US); Jason L. Chua, Glenview, IL (US)

Correspondence Address: LUMEN PATENT FIRM, 350 Cambridge Avenue, Suite 100, PALO ALTO, CA, 94306, US

(21) Appl. No.: 12/802,063

(22) Filed: May 27, 2010

Related U.S. Application Data
(60) Provisional application No. 61/217,181, filed on May 27, 2009.

(51) Int. Cl. F16K 31/12; F16K 31/48

(52) U.S. Cl. 137/565.01; 137/624.18

(57) ABSTRACT

Provided is a sequenced fluid control device that includes a pneumatic driver module, a fluid cartridge having at least one fluid chamber and at least one waste chamber, and at least one sample delivery element disposed to sealably contact the fluid cartridge forming a main chamber containing a sample, where the fluid cartridge is also disposed to sealably contact the pneumatic driver module. The pneumatic driver module injects gas into or withdraws gas from the fluid cartridge, where the gas directly contacts at least one fluid causing at least one fluid to flow through channels disposed to connect at least one fluid chamber to the sample delivery element and disposed to connect the sample delivery element to the at least one waste chamber or waste channel, where a sample on the sample delivery element is exposed to the at least one fluid.

### CROSS-REFERENCE TO RELATED APPLICATIONS

This application claims priority from U.S. Provisional Patent Application 61/217,181 filed May 27, 2009, and which is incorporated herein by reference.

### FIELD OF THE INVENTION

The invention relates to control of fluid transport. In particular, the invention relates to a device for exposing samples carried by a sample delivery element to a sequence of fluids from a fluid cartridge using pneumatic force provided by a pneumatic driver module.

### BACKGROUND

Microfluidic or minifluidic devices are useful for treating or analyzing chemical and biological samples. Such devices can be useful for treating or analyzing small samples, such as solid samples on a centimeter to micron scale or fluid samples on a milliliter to picoliter scale. Microfluidic or minifluidic devices can have channels be arranged to perform operations such as mixing, dispensing, sample flow, detection, incubation of samples and reagents, conducting electrophoresis, and the like.

Current limitations in the art include the difficulty of introducing samples to microfluidic or minifluidic devices, because samples such as biological cells or fluids, tissue sections, chemical precursors, or cell lysates are often attached to or borne by a sample delivery element which is useful for supporting, carrying, or protecting the sample during exposure to the microfluidic or minifluidic device, or thereafter during further processing or analysis steps. An example of such a sample delivery element is a microscope slide attached to a sample such as thin biological tissue sections, which must first be exposed to a sequence of antibody staining reagents before being mounted under a cover slip and analyzed on a microscope. Another example of a sample delivery element is a multi-well plate bearing cell lysate which is to be exposed to a sequence of reagents for an ELISA test, after which the plate is analyzed using a plate reading device such as a fluorimeter or spectrophotometer. Further limitations in the art include contamination, particularly when performing different tests on a variety of samples, where substantial cleaning is required to minimize these problems.

Accordingly, there is a need to develop a microfluidic or minifluidic device that is useful for exposing a sample carried by a given sample delivery element to a sequence of fluid reagents, and for exposing many such sample delivery elements to such sequences over time without inducing contamination from one sample to the next.

### SUMMARY OF THE INVENTION

The present invention provides a sequenced fluid control device that includes a pneumatic driver module, a fluid cartridge, where the fluid cartridge includes at least one fluid chamber and at least one waste chamber or channel, and the sequenced fluid control device includes at least one sample delivery element disposed to sealably contact the fluid cartridge, where the fluid cartridge is also disposed to sealably contact the pneumatic driver module. The pneumatic driver module injects gas into or withdraws gas from the fluid cartridge, where the gas directly contacts at least one liquid or suspension causing the at least one liquid or suspension to flow through channels disposed to connect the at least one fluid chamber to the sample delivery element and disposed to connect the sample delivery element to the at least one waste chamber, where at least one sample on the sample delivery element is exposed to the at least one liquid or suspension.

In one aspect of the invention, the pneumatic driver module includes a suitably programmed computer disposed to operate the pneumatic driver module, where results from the operation can be output from the computer.

In a further aspect of the invention, the pneumatic driver module includes a pump disposed to provide a driving force such as a gas pressure or a vacuum.

According to another aspect of the invention, the pneumatic driver module includes a network of pneumatic ports, where the pneumatic ports connect a pneumatic pump to at least one port on the sample delivery element, where the pneumatic ports are opened and closed by at least one valve. Here, the pneumatic ports can include tubes or channels, where the channels are formed in a housing of the pneumatic driver module.

In another aspect of the invention, the sample delivery element can be a microscope slide, a well-plate, a Petri dish, a cover slip, a microcentrifuge tube, a cuvette, a tube, a tissue culture flask, a tissue culture dish, a rigid surface, or a semi-rigid surface.

According to one aspect of the invention, the fluid cartridge includes a top gasket, a top layer, a middle layer, a bottom layer and a bottom gasket, where the top gasket is disposed on the top layer, the top layer is disposed on the middle layer, the middle layer is disposed on the bottom layer and the bottom layer is disposed on the bottom gasket, where the bottom gasket forms a main chamber on the sample delivery element when the sample delivery element is sealably engaged to the fluid cartridge, where the main chamber includes a top surface of the sample delivery element, an inner surface of the bottom gasket and a bottom surface of the bottom layer. In one aspect, the top gasket includes openings, where the openings are aligned with ports in the top layer, where a pneumatic force is applied through at least one the opening. In a further aspect, the ports in the top layer are disposed to receive a pipette-dispensed solution. In another aspect, the bottom layer includes the fluid cartridge channels disposed to connect the at least one fluid chamber in the middle layer to the main chamber in the bottom gasket, where the fluid cartridge channels are further disposed to connect the main chamber to a waste chamber in the middle layer. According to one aspect, the main chamber includes phase guide features formed in the bottom surface of the bottom layer, where the phase guide features can be ridges, grooves, patterns of surfaces with varying contact angles, or any combination thereof.

In another aspect of the invention, the fluid cartridge includes liquid sensors disposed to detect properties such as a presence of the liquid, a pressure of the liquid, a temperature of the liquid, or a flow rate of the liquid.

In a further aspect of the invention, the fluid cartridge includes markings disposed to indicate an insertion direction to the pneumatic driver module, or contents of the fluid chamber.

In yet another aspect of the invention, the pneumatic driver module includes a plurality of fluid cartridge berths disposed to receive at least one the fluid cartridge and at least one the sample delivery element.

In a further aspect of the invention, the fluid cartridge includes indexing features disposed to position the fluid cartridge and the sample delivery element with the pneumatic driver module.

According to one aspect of the invention, the sample delivery element and the fluid cartridge frictionally engage the pneumatic driver module.

In another aspect of the invention, at least one barrier prevents flow of liquid from the fluid cartridge to the pneumatic driver module, where the barrier uses mechanisms such as gravitational separation, hydrophobic porous membranes, menisci with finite pressure differences, liquid check valves, liquid-from-gas separator structures, or septa.

According to a further aspect of the invention, at least one pneumatic port connects to an external sealed container and is connected to the at least one fluid cartridge, where a solution in the external sealed container is delivered from the external sealed container to the at least one fluid cartridge.

In another aspect of the invention, the waste chamber is connected to an external waste container.

According to another aspect of the invention, at least one fluid cartridge channel is disposed to provide gas flow from at least one opening to a main chamber formed by the sample delivery element sealably coupled to the fluid cartridge.

### BRIEF DESCRIPTION OF THE FIGURES

The objectives and advantages of the present invention will be understood by reading the following detailed description in conjunction with the drawing, in which:

FIGS. 1a-1b show perspective exploded views of the fluid cartridge according to the present invention.

FIGS. 2a-2c show perspective exploded and collapsed views of the fluid cartridge and sample delivery element assembly according to the current invention.

FIGS. 3a-3c show perspective views of the pneumatic driver module with fluid cartridge and sample delivery assembly, and an exploded view of the pneumatic network in the pneumatic delivery module according to the present invention.

FIG. 4 shows a schematic diagram of flow of substances between the three primary components according to the present invention.

### DETAILED DESCRIPTION OF THE INVENTION

Although the following detailed description contains many specifics for the purposes of illustration, anyone of ordinary skill in the art will readily appreciate that many variations and alterations to the following exemplary details are within the scope of the invention. Accordingly, the following preferred embodiment of the invention is set forth without any loss of generality to, and without imposing limitations upon, the claimed invention.

The current invention provides a modular device and method for a procedure involving a sequence of transport steps moving fluids to and from a sample delivery element without inducing contamination of a sample or reagents from one procedure with sample or reagents from a previous procedure. As shown in the figures and described below, the invention includes a fluid cartridge, and sample delivery element that are disposed to sealably engage each other forming at least one main chamber each of which contains at least one sample. The fluid cartridge is also disposed to sealably engage a pneumatic driver module. A top gasket seals pneumatic control ports on the fluid cartridge to corresponding pneumatic control ports on the pneumatic driver module. In one exemplary embodiment the fluid cartridge has four pneumatic control ports, and one vent. Three of the pneumatic control ports are connected to liquid reservoirs, such as reagent reservoirs, in a middle layer of the fluid cartridge and are used for forcing liquid to flow out of these chambers and into the main chamber. A fourth port is used for conducting air directly to a main chamber to flush liquid off of the sample delivery element and into a waste chamber. The top layer of the fluid cartridge contains four holes, which lead to the four chambers in the middle layer. A user can use a standard pipetor or syringe and needle to inject primary and secondary antibody solutions into the two holes that lead to the two smaller chambers, and to inject wash solution into the hole leading to a medium-sized chamber, where the middle layer of the fluid cartridge contains multiple chambers. In this example, there are four chambers: two smaller ones, which will contain the antibody solutions, the larger middle chamber, which will contain the wash solution, and the largest chamber will contain the waste.

The main chamber has two holes connecting it to the middle layer of the fluid cartridge: an inlet hole and an outlet hole. Liquid that can either be a solution, a suspension of particles, cells, or bubbles in a liquid/solution, effervescence, an emulsion, or gas can be driven and/or drawn from the reservoirs of the fluid cartridge through the inlet hole into the main chamber. From there it can be driven and/or drawn through the outlet hole and into the waste chamber or waste channel of the fluid cartridge.

The bottom layer of the fluid cartridge has features on its upper and lower sides. The upper side contains channels leading from the two reagent or antibody chambers and the wash chamber to the inlet of the main chamber, and a channel leading from the outlet of the main chamber to the waste chamber. The lower side has ridges or grooves which act as “phase guides” to guide the meniscus of the liquid as it flows through the main chamber over a microscope slide, for example, to prevent air bubbles from being created.

The top gasket seals the fluid cartridge to the pneumatic driver module base, and the bottom gasket seals the fluid cartridge to the sample delivery element forming the main chamber.

The pneumatic driver module includes the base and optionally a wired or wireless connection to a computer and the controlling software on the computer. The base includes an air pump, a chamber which can be pressurized by the pump and which has multiple ports that are normally closed by valves, and control electronics, which control the timing of the operating of the pump and valves. Clamps can be provided for clamping the fluid cartridge and sample delivery element assemblies to the base, with microchannels or tubes connecting the valves to pneumatic control ports on surfaces of the clamps. The user can install multiple assemblies each including a fluid cartridge and a sample delivery element in multiple clamps.

The controlling software may allow the user to specify the sequence in which the reagents will be delivered to the sample and parameters such as the duration for which the sample will be incubated with each liquid before the liquid is removed to the waste chamber, the temperature at which each step will be carried out, shaking or mixing steps, light exposure steps, or measurements to be taken at specific times such as temperature, fluorescence, or concentrations. The user may create a new procedure or load and edit a stored procedure and may store their procedure. The software may also create and store a log of the progress of each procedure. The controlling software may be run on a microprocessor with memory within the control electronics in the base or on a computer connected by a wired or wireless connection to the base. The base may include controls and display elements for entering the parameters of the procedure and for operating the software program and viewing the results. Parameters for the procedures may also be downloaded from a computer to the electronics on the base after which the computer may be disconnected from the base, which may be operated independently of the base.

The valves can be operated by a servo arm, which moves in an arc pushing one of a set of valve levers at a time. A valve lever is normally sealed against an o-ring surrounding the port. When one of the valve arms is pushed down by the arm of the servo motor, the corresponding pneumatic port is opened allowing pressurized air to flow from the pressurizable chamber through the microchannels to one of the pneumatic control ports on the clamp from where it enters the corresponding port on a cartridge, causing fluid to flow between the fluid cartridge and sample delivery element. The pump may also generate a vacuum in the pressurizable chamber, which can also be used to cause fluid to flow between the sample delivery element and the fluid cartridge.

In operation, the user pipets or syringe-injects antibody solution(s) and wash solution into the holes on the top of the fluid cartridge, places a sample delivery element such as a microscope slide with tissue sections attached against the gasket on the bottom of the fluid cartridge, holds the fluid cartridge and sample delivery element assembly by the ends or middle using their thumb and finger, places the assembly into one of the fluid cartridge berths, which may include clamps on the base, and runs the controlling software. After the antibody stainer has finished executing the program, the user slides the assembly out of the fluid cartridge berths on the base, pulls the sample delivery element off of the fluid cartridge, disposes of the fluid cartridge (which now contains the waste solutions from the antibody staining procedure), and may proceed to further process or analyze the samples on the slide.

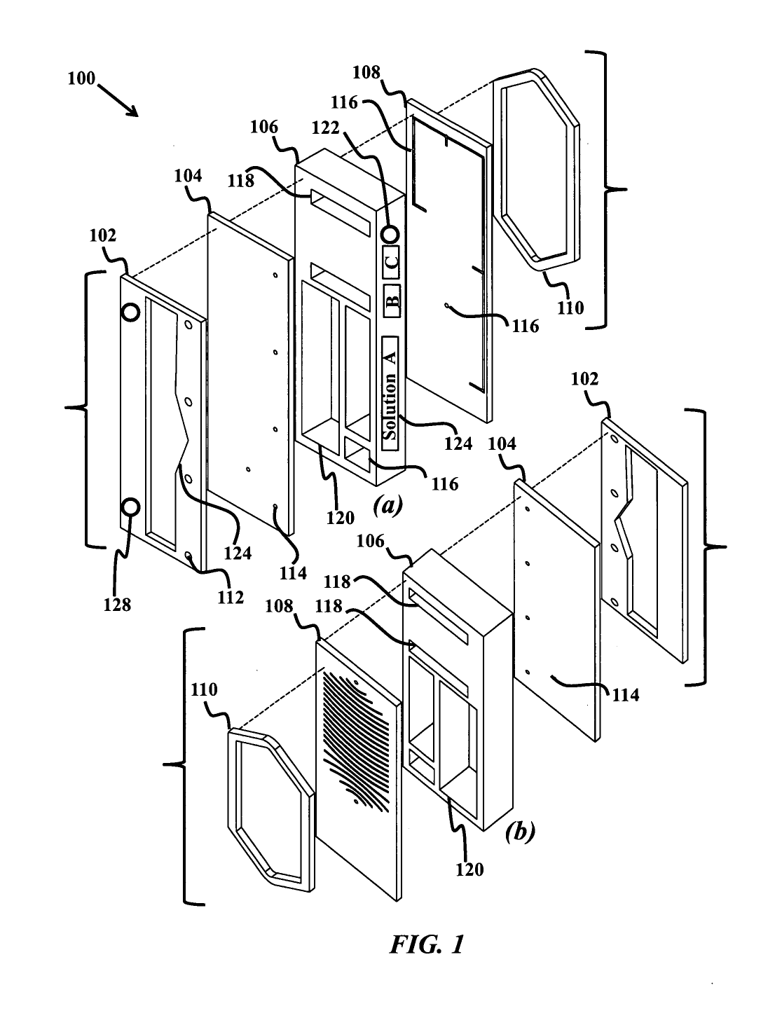

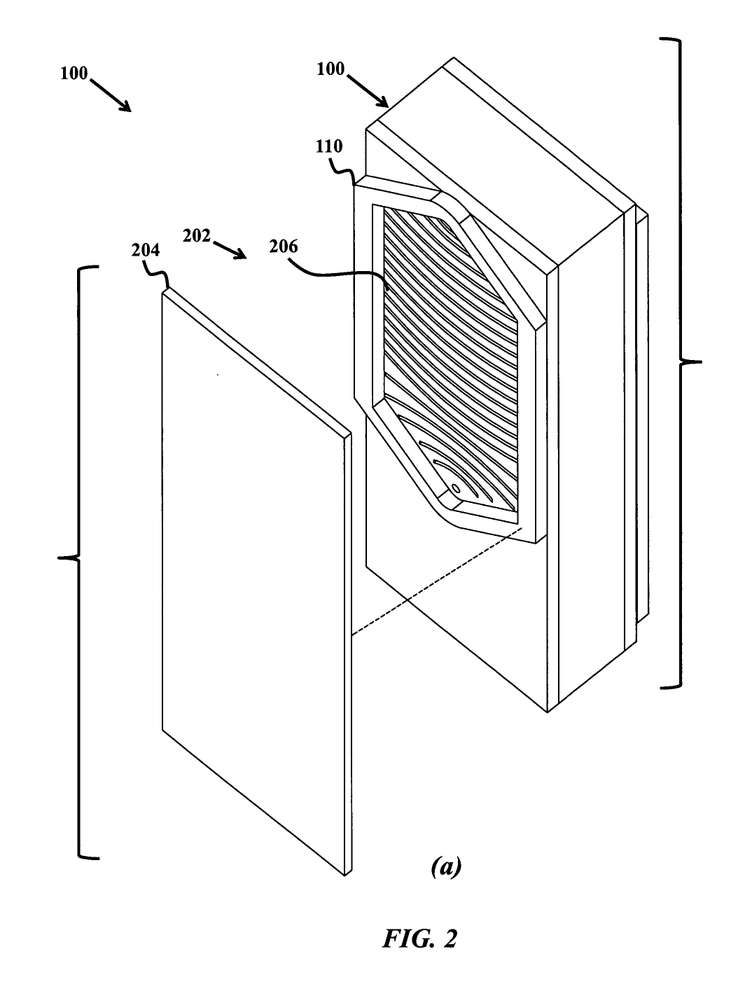

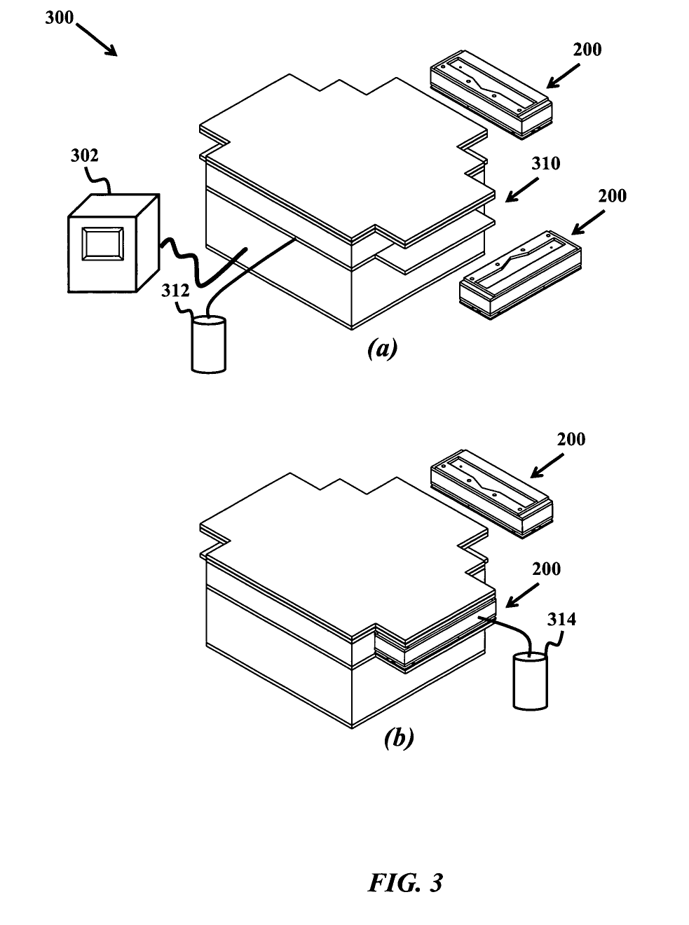

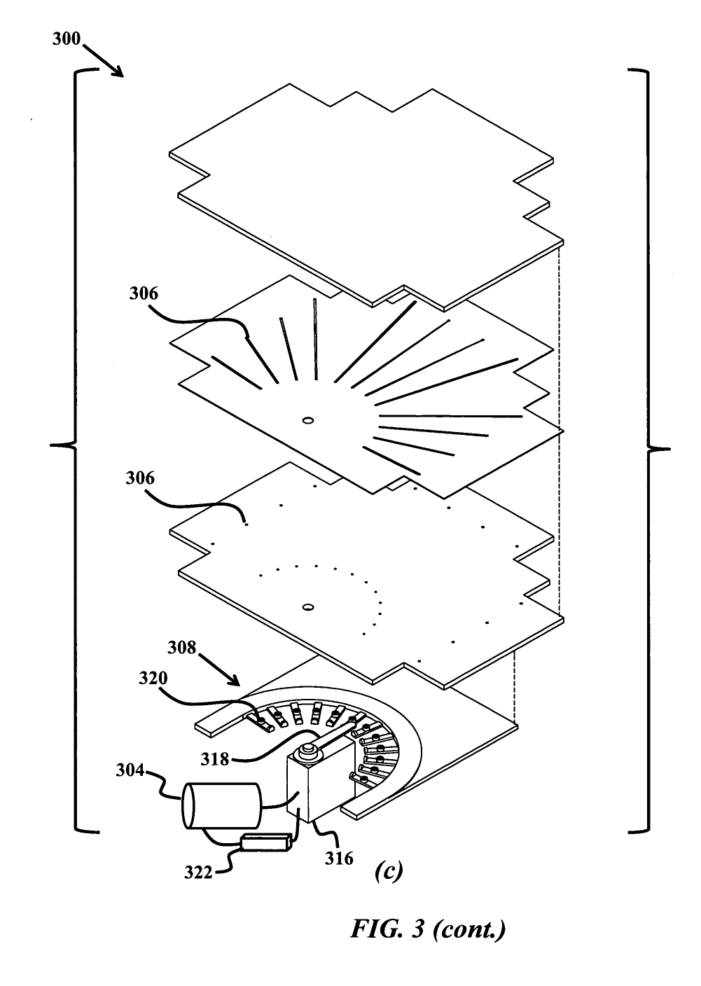

Referring now to the figures, the current invention provides a modular device and method for moving fluids to and from a disposable sample delivery element without inducing contamination from a previous sample test procedure. The invention includes a fluid cartridge that sealably engages a sample delivery element and pneumatic driver module. FIGS. 1a-1b show perspective exploded views of the fluid cartridge 100 according to the present invention. The fluid cartridge 100 includes a top gasket 102, a top layer 104, a middle layer 106, a bottom layer 108 and a bottom gasket 110, where the top gasket 102 is disposed on the top layer 104, the top layer 104 is disposed on the middle layer 106, the middle layer 106 is disposed on the bottom layer 108 and the bottom layer 108 is disposed on the bottom gasket 110. The top gasket 102 includes openings 112 aligned with ports 114 in the top layer 104, where a pneumatic force is applied through at least one opening 112. Here, the ports 114 in the top layer 104 can be disposed to receive a pipet-dispensed or syringe-injected solution. The fluid cartridge 100 can further include solution sensors 122 disposed to detect properties such as a presence of the solution, a pressure of the solution, a temperature of the solution, or a flow rate of the solution, and electrical contacts for communication between sensors and the control system. In one aspect of the invention, the fluid cartridge 100 includes markings 124 disposed to indicate an insertion direction to the pneumatic driver module or contents of the fluid chambers 118. In a further aspect of the invention, the fluid cartridge 100 includes indexing features 128 disposed to position the fluid cartridge 100 and the sample delivery element 204 with the pneumatic driver module (see FIGS. 3a-3b). The sample delivery element 204 and the fluid cartridge 100 can frictionally engage the pneumatic driver module 300. The fluid cartridge 100 can be disposable and prevent contamination of the dry pneumatic driver module 300 with liquids or suspensions chambers 118 in the fluid cartridge 100, so that subsequent fluid cartridges 100 are not contaminated.

The top 102, middle 106, and lower 108 layers can be rigid pieces of plastic which are sealed together, for example using heat sintering, glue or cement, double-sided adhesive tape or plastic, ultrasonic welding, or laser welding. Optionally, multiple layers may be made out of a single piece of raw material. The pieces may be made by injection molding, machining, hot embossing, or other methods.

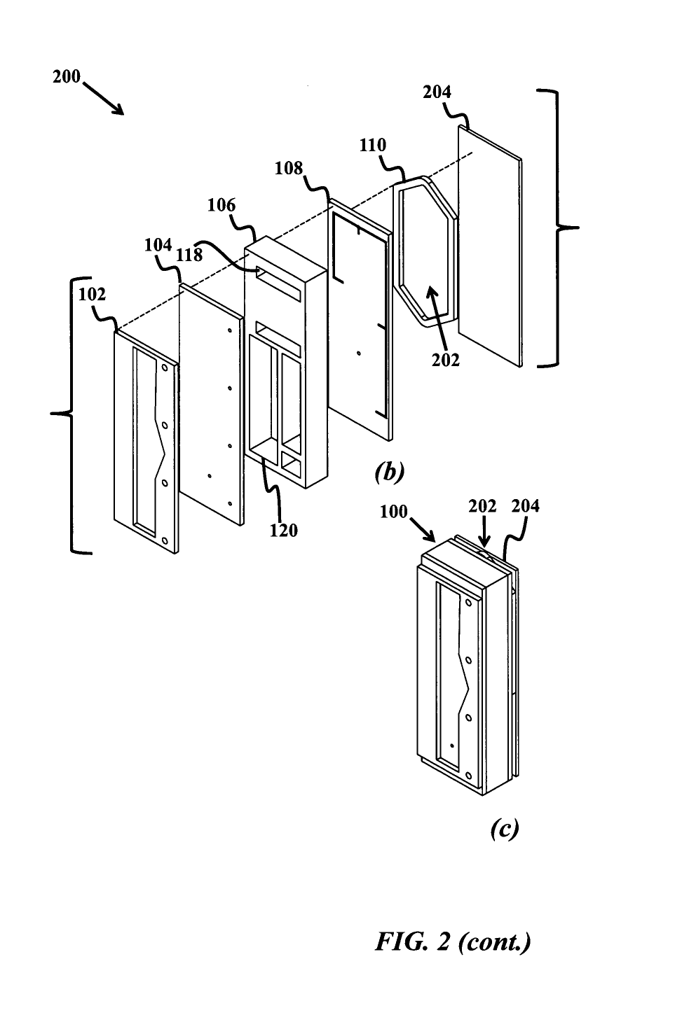

Referring now to FIGS. 2a-2c, where shown are perspective exploded and collapsed views of the assembly 200 that includes the fluid cartridge 100 and sample delivery element 204 according to the current invention. As shown, the bottom layer 108 and the bottom gasket 110 form a main chamber 202 on the sample delivery element 204 when the sample delivery element 204 is sealably engaged to the fluid cartridge 100, where the main chamber 202 includes a top surface of the sample delivery element 204, an inner surface of the bottom gasket 110 and a bottom surface of the bottom layer 108. The sample delivery element 204 can be a microscope slide, a multi-well plate, a Petri dish, a cover slip, a microcentrifuge tube, a cuvette, a tube, a tissue culture flask, a tissue culture dish, a rigid surface, or a semi-rigid surface. The bottom gasket 110 and bottom layer 108 can have shapes which dispose them to form a seal with the sample delivery element 204. The bottom gasket 110 may have additional discrete pieces, which may be optionally removed by the user to allow the user to customize the shape of the main chamber 202 to minimize reagent use or encompass a sample of a given size.

As shown in FIG. 1a with FIG. 2b, the bottom layer 108 has channels 116 disposed to connect at least one reservoir 118 in the middle layer to the main chamber 202 and connect the main chamber 202 to a waste chamber 120, which can also be interpreted as a waste channel or waste reservoir, in the middle layer 106. The main chamber 202 includes phase guide features 206 formed in the bottom surface of the bottom layer 108, where the phase guide features 206 can be ridges, grooves and/or patterns of surfaces with varying contact angles. The user places the sample delivery element 204 with the sample to be stained with antibodies, for example, against the bottom gasket 110, thereby completing formation of the main chamber 202. One of the unique features of the invention is that a microfluidic network is formed by the assembly of the fluid cartridge 100 and the sample delivery element 204.

In one aspect of the invention, at least one fluid cartridge channel 116 can be disposed to provide gas flow from at least one opening to the main chamber 202 to allow liquid or suspension to be flushed with gas from main chamber 202 into waste chamber 120.

Referring now to FIGS. 3a-3c, shown is the a pneumatic driver module 300, and the assembly 200 that includes the fluid cartridge 100 and sample delivery element 204 with the sample delivery element 204 disposed to sealably contact the fluid cartridge 100, which is sealably engaged to the pneumatic driver module 300, where the pneumatic driver module 300 injects gas into or withdraws gas from the fluid cartridge 100, where the gas directly contacts at least one liquid, such as a solution, emulsion, or suspension, causing at least one liquid, solution or suspension to flow through channels 116 (see FIGS. 1a-2c). FIG. 3a shows the pneumatic driver module 300, which includes a connector 302 for connecting the pneumatic driver module to a suitably programmed computer/controller 302 that is disposed to operate the pneumatic driver module 300 or download user-provided operating parameters to memory in control circuit 324, where results from the operation can be output from the pneumatic driver module 300 to the computer/controller 302 via a connector or via a wireless connection. The pneumatic driver module 300 includes a pump 304 disposed to provide a driving force such as a gas pressure or a vacuum. The pneumatic driver module 300 includes a network of pneumatic ports 306 that connect a pneumatic pump 304 to at least one port 112 on the fluid cartridge 100, where the pneumatic ports 306 are opened and closed by at least one valve 308. Here, the pneumatic ports 306 can be tubes or channels, where the channels are formed in a housing of the pneumatic driver module 300. The invention is capable of generating a sequence of pressures at the pneumatic ports 306.

Further shown, the pneumatic driver module 300 includes a plurality of pneumatic driver berths 310 disposed to receive at least one fluid cartridge and sample delivery element assembly 200. According to one aspect of the pneumatic driver module 300 or the fluid cartridge 100 have at least one barrier that prevents flow of fluid from the fluid cartridge 100 to the pneumatic driver module 300, where the barrier uses mechanisms such as gravitational separation, hydrophobic porous membranes, menisci with finite pressure differences, fluid check valves, fluid-from-gas separator structures, or septa. Further, at least one pneumatic port 306 connects to an external sealed container 312 which in turn is connected to the at least one fluid cartridge 100, where a solution in the external sealed container 312 is delivered from the external sealed container 312 to at least one fluid cartridge 100. In another aspect, the waste chamber or waste channel 120 is connected to an external waste container 314 (see FIG. 3c). A single actuator 316 actuates multiple pneumatic valves 308, simplifying control and reducing the cost of the device. The single actuator 316 may be a servo motor, which moves an arm 318 to one of multiple levers 320, thereby lifting a single lever 320 at a time, opening a pneumatic port which is normally closed by the lever 320. To prevent unwanted flow of gas, pump 304 may be turned off as lever arm 318 rotates past levers 320 on its way to opening a specific lever 320. In one aspect of the invention, a pump-servo controller 322 is provided to operate the pressures from the pump 304 in conjunction with the positioning and operation of the actuator 316.

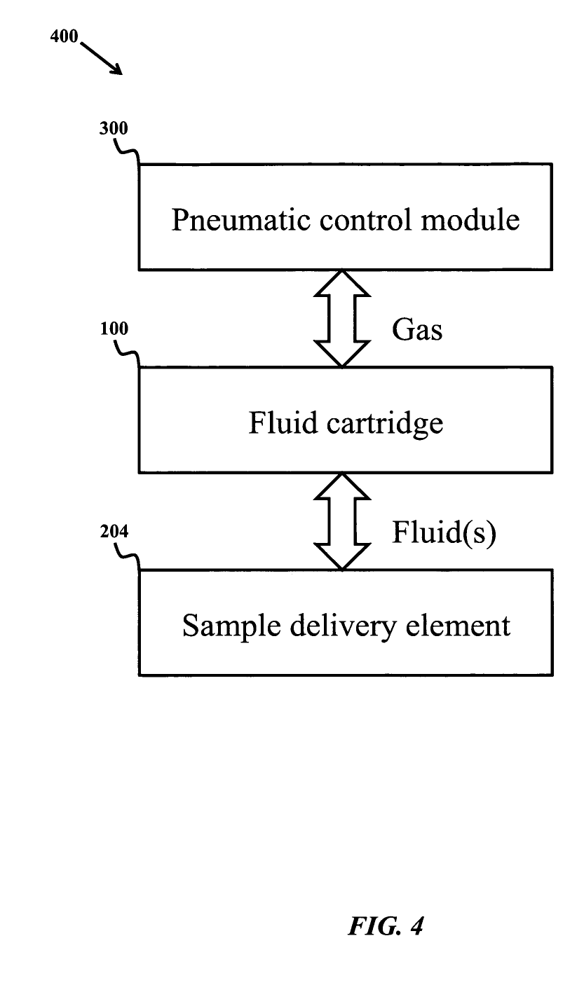

FIG. 4 shows a schematic diagram 400 of flow of substances between the three primary components, where FIG. 4, shows a pneumatic control module 300, a fluid cartridge 100, and a sample delivery element 204. Gas from the pneumatic control module 300 causes at least one of the following fluids to flow between the fluid cartridge 100 and the sample delivery element 204: a liquid, solution, or emulsion, or a suspension of cells, bubbles, or particles. In addition, gas from the pneumatic control module 300 may flow through the fluid cartridge 100 to the sample delivery element 204.

The current invention provides many advantages that include minimizing antibody use due to the minimal dead volume in the system and the fact that the main chamber 202 can be made very shallow in depth, minimizing the volume of the solution required to cover the samples on a microscope slide for example. The invention prevents evaporation of solutions during antibody staining due to the enclosed main chamber 202 and provides more reproducible results and requires far less time than manual antibody staining. The invention enables ease of use, where the user adds antibody solution and wash solution to the chambers 118, easily places a sample delivery element 204 on the bottom of the fluid cartridge 100, slides the fluid cartridge 100 into the fluid cartridge berths 310, and runs the controlling software, where the invention prevents contamination between samples.

The present invention has now been described in accordance with several exemplary embodiments, which are intended to be illustrative in all aspects, rather than restrictive. Thus, the present invention is capable of many variations in detailed implementation, which may be derived from the description contained herein by a person of ordinary skill in the art. For example clamps on the fluid cartridge berths in the pneumatic driver module and on the fluid cartridge can have ridges that align and fit the fluid cartridge into place. The clamps on the pneumatic driver module can have thin extrusions that align with the gasket on the fluid cartridge. The fluid cartridge can have bumps on either side that fit into cuts in the fluid cartridge berths in the pneumatic driver module. The fluid cartridge can have a small hemispherical extrusion that fits into a cut in the fluid cartridge berths in the pneumatic driver module. This hemisphere can be a ball acted on by a spring that snaps into place. The fluid cartridge can have two cuts that run down the length of either side, which fit into two extrusions in the fluid cartridge berths in the pneumatic driver module, so it slides in the right place. The pneumatic driver module can have walls or pillars that attach top and bottom surfaces of the fluid cartridge berths in the pneumatic driver module. These walls or pillars can guide the fluid cartridge into place.

Further variations include the single actuator being a stepper motor or servo motor, which turns a worm screw and moves a slotted shaft in a tube, with pneumatic ports along the wall of the tube, such that only the hole at the position of the slot is open. The single actuator can be a motor, which rotates a disk with a hole or a slot in it, such that the disk normally blocks several holes in a surface, except for a hole aligned with the hole or slot in the disk. Instead of a single actuator actuating multiple valves, discrete valves may be used, for example, discrete solenoid valves.

According to the invention, other variations can include device operation may be controlled via a radio link to a computer. The operating program may be downloaded onto the device so that it may be used independently of a computer. The device may have indicators, lights, screens, and controls such as buttons, touch-screens, and dials for control independent of a computer.

Additional variations include the formation of more than one main chamber between each fluid cartridge and sample delivery element. In such embodiments the sample in each main chamber may be exposed to a different sequence of reagent liquids or suspensions due to connections between the pneumatic ports and the reagent chambers and the inlets of the main chambers being different for some main chambers than for other main chambers.

In a further variation a screen or filter may prevent the sample from being carried from the main chamber to the waste chamber or channel.

In a further variation on the invention, valves in the liquid cartridge may be used to direct, allow, or prevent the flow of fluid from the liquid cartridge to the sample delivery element or from the sample delivery element to the waste chamber.

In another variation on the invention, one of the fluids in the fluid cartridge is a sample, and the sample delivery element does not contain a sample but instead contains a reagent or substance to which the sample is to be exposed. In this variation, the waste chamber may be replaced by an output reservoir to which the sample is delivered after being exposed to the sample delivery element, and from which the sample may be removed after the fluid cartridge is removed from its berth on the pneumatic control module.

Additional variations include the device used in applications other than antibody staining of tissue sections on microscopes slides; for example, ELISA assays or cell culture. Additionally, air pressure to the device may be supplied by a port connected to an air supply from a building. There may be more than one pump, and some of the pumps may supply vacuum pressure to help move liquid through the fluid cartridge. The pressure or vacuum may be supplied by a connector on the housing of the pneumatic driver module, which can be connected to an external source of pressure or vacuum such as a gas tank or a pressure supply system in a building. The base may have fewer or more than three fluid cartridge berths. Gas flow can clear at least part of the fluid cartridge of fluid. The waste chamber or waste channel can have a vent to the atmosphere or to one of the pneumatic ports.

The device may be powered by various means, for example by an AC/DC adapter plug, or a USB connection to a computer, or by batteries for cases in which the device must be operated in an isolated environment such as a cell incubator or refrigerator.

When the sample delivery element is on the same side of the fluid cartridge as the input ports, the fluid cartridge includes a gasket, a cartridge housing, and a micron or millimeter-scale fluidic network, where the gasket is disposed on the fluid cartridge housing, and forms at least one main chamber on the sample delivery element when the sample delivery element is sealably engaged to said fluid cartridge, where the main chamber has a surface of the sample delivery element, an inner surface of said gasket and a surface of said cartridge housing.

According to further variations, the berths on the pneumatic driver module for engaging the fluid cartridge and the sample delivery element have at least one of the following mechanisms: i) two rigid, semi-rigid, or flexible sheets which are fixed substantially parallel to each other and between which the fluid cartridge and sample delivery element assembly is slid, engaging the sheets frictionally due to elasticity of the sheets or with elements of the assembly such as compressible gaskets; ii) a hinged or rotated lid which is closed on the assembly and which is held closed with a clip, magnet, catch, or clasp; iii) a spring loaded clamp; iv) a clip; v) elastics; vi) springs; vii) slots into which features of the assembly slide; viii) two rigid or semi-rigid sheets held together by an elastic mechanism such as a spring.

Liquid sensors can be optical, conductivity-based, or pressure-based. At least one pressure sensor can communicate measurements to a control system to determine when the main chamber has been flushed of fluid with gas by detecting a drop in fluidic resistance. The fluid cartridge or pneumatic driver module can contain at least one sensor which monitors the progress of reactions in the main chamber and communicates this information to the control system and can be one of the following: pH sensors, thermometers, colorimetric sensors, light sensors, conductivity sensors, and concentration sensors. Gold-plated electrical contacts can communicate information between sensors in the fluid cartridge and the control system. The control system can include electronics for operating valves, pumps, heaters, coolers, lights, mixers, sonicators, thermometers, light sensors, cameras, pressure sensors, or other actuators or sensors and either: i) a suitable software program running on a computer connected by a wired or wireless connection to the pneumatic driver module; or, ii) suitable software or firmware program running on an electronic circuit containing a microprocessor and memory within the pneumatic driver module. The software can allow the user to specify one or more of the following: the sequence of liquids to be applied to the sample, the duration for which each liquid will remain on the sample, the sequence of temperatures at which the sample is to be maintained, the rate at which liquids are added to or removed from the sample, the sequence of exposures of the sample to light, a sequence of physical manipulations of the sample such as heating or vibrating or mixing using magnets stirring magnetic particles in the reagent reservoirs or main chamber, a sequence of measurements of the sample to be acquired and optionally stored. The software or firmware in the electronic circuit is programmed through the connection to the computer after which the fluid control device may be disconnected from and be operated independently of the computer. The duration for which pressure is applied to fill or empty the main chamber is determined by one or more methods that include: i) measuring the amount of time required to fill or empty the main chamber and storing this value in the computer or the electronic circuit; ii) using information from at least one sensor located in the fluid cartridge or the pneumatic driver module. The pneumatic driver module includes input and output devices for operating the device using buttons, keypads, displays, LEDs, knobs, dials, and touch-screens. The sample delivery element can further include, a microcentrifuge tube, a cuvette, a tube, a tissue culture flask, a tissue culture dish, or a custom-shaped rigid or semi-rigid surface or container suitable for holding a sample of a given size or shape.

The invention can further include elements for protecting one or more of the liquids from light, such as a cover, or use of opaque materials for construction of the fluid cartridge or pneumatic driver module, or both. A camera/optical system can be provided to take images of the sample. Actuators for manipulating the sample can include sonicators, heaters, coolers, irradiators, and mixers. Mixers may include magnetic elements pre-loaded into the reagent reservoirs and magnetic rotors on motors, or gas jets injected into reagent reservoirs or the main chamber, or vibrations produced by eccentric masses on motor shafts or piezo crystals. The invention can include a temperature control mechanism such as a Peltier crystal and a temperature sensor connected to the control circuit to maintain the main chamber at a sequence of temperatures. The reagent reservoirs can be preloaded with wet or dry reagents. The size of the main chamber can be adjusted by the user by using different gasket sizes and shapes in order to fit a given sample size and minimize reagent usage.

All such variations are considered to be within the scope and spirit of the present invention as defined by the following claims and their legal equivalents.

What is claimed:

1. A sequenced fluid control device comprising:
a. a pneumatic driver module;
b. a fluid cartridge, wherein said fluid cartridge comprises at least one fluid chamber and at least one waste chamber; and
c. at least one sample delivery element, wherein said at least one sample delivery element is disposed to sealably contact said fluid cartridge, wherein said fluid cartridge is also sealably engaged to said pneumatic driver module, wherein said pneumatic driver module injects gas into or withdraws gas from said fluid cartridge, wherein said gas directly contacts at least one liquid or suspension causing said at least one liquid or suspension to flow through channels disposed to connect said at least one fluid chamber to said sample delivery element and disposed to connect said sample delivery element to said at least one waste chamber or channel, wherein at least one sample on said sample delivery element is exposed to said at least one liquid or suspension.

2. The sequenced fluid control device of claim 1, wherein said pneumatic driver module comprises a suitably programmed computer disposed to operate said pneumatic driver module, wherein results from said operation can be output from said computer.

3. The sequenced fluid control device of claim 1, wherein said pneumatic driver module comprises a pump, wherein said pump is disposed to provide a driving force selected from the group consisting of a gas pressure and a vacuum.

4. The sequenced fluid control device of claim 1, wherein said pneumatic driver module comprises a network of pneumatic ports, wherein said pneumatic ports connect a pneumatic pump to at least one port on said sample delivery element, wherein said pneumatic ports are opened and closed by at least one valve.

5. The sequenced fluid control device of claim 4, wherein said pneumatic ports comprise tubes or channels, wherein said channels are formed in a housing of said pneumatic driver module.

6. The sequenced fluid control device of claim 1, wherein said sample delivery element is selected from the group consisting of a microscope slide, a well-plate, a Petri dish, a cover slip, a microcentrifuge tube, a cuvette, a tube, a tissue culture flask, a tissue culture dish, a rigid surface, and a semi-rigid surface.

7. The sequenced fluid control device of claim 1, wherein said fluid cartridge comprises a top gasket, a top layer, a middle layer, a bottom layer and a bottom gasket, wherein said top gasket is disposed on said top layer, said top layer is disposed on said middle layer, said middle layer is disposed on said bottom layer and said bottom layer is disposed on said bottom gasket, wherein said bottom gasket forms a main chamber on said sample delivery element when said sample delivery element is sealably engaged to said fluid cartridge, wherein said main chamber comprises a top surface of said sample delivery element, an inner surface of said bottom gasket and a bottom surface of said bottom layer.

8. The sequenced fluid control device of claim 7, wherein said top gasket comprises openings, wherein said openings are aligned with ports in said top layer, wherein a pneumatic force is applied through at least one said opening.

9. The sequenced fluid control device of claim 8, wherein said ports in said top layer are disposed to receive a pipette-dispensed solution.

10. The sequenced fluid control device of claim 7, wherein said bottom layer comprises said fluid cartridge channels disposed to connect said at least one fluid chamber in said middle layer to said main chamber in said bottom gasket, wherein said fluid cartridge channels are further disposed to connect said main chamber to a waste chamber in said middle layer.

11. The sequenced fluid control device of claim 7, wherein said main chamber comprises phase guide features formed in said bottom surface of said bottom layer, wherein said phase guide features comprise i) ridges, ii) grooves, iii) patterns of surfaces with varying contact angles, i) and ii), i) and iii), ii) and iii), or i) and ii) and iii).

12. The sequenced fluid control device of claim 1, wherein said fluid cartridge comprises liquid sensors, wherein said liquid sensors are disposed to detect properties selected from the group consisting of a presence of said liquid, a pressure of said liquid, a temperature of said liquid, and a flow rate of said liquid.

13. The sequenced fluid control device of claim 1, wherein said fluid cartridge comprises markings, wherein said markings are disposed to indicate an insertion direction to said pneumatic driver module, or contents of said fluid chamber.

14. The sequenced fluid control device of claim 1, wherein said pneumatic driver module comprises a plurality of fluid cartridge berths disposed to receive at least one said fluid cartridge and at least one said sample delivery element.

15. The sequenced fluid control device of claim 1, wherein said fluid cartridge comprises indexing features, wherein said indexing features are disposed to position said fluid cartridge and said sample delivery element with said pneumatic driver module.

16. The sequenced fluid control device of claim 1, wherein said sample delivery element and said fluid cartridge frictionally engage said pneumatic driver module.

17. The sequenced fluid control device of claim 1, wherein at least one barrier prevents flow of liquid from the fluid cartridge to the pneumatic driver module, wherein said barrier uses mechanisms selected from the group consisting of gravitational separation, hydrophobic porous membranes, menisci with finite pressure differences, liquid check valves, liquid-from-gas separator structures, and septa.

18. The sequenced fluid control device of claim 1, wherein at least one pneumatic port connects to an external sealed container and is connected to said at least one fluid cartridge, wherein a solution in said external sealed container is delivered from said external sealed container to said at least one fluid cartridge.

19. The sequenced fluid control device of claim 1, wherein said waste chamber is connected to an external waste container.

20. The sequenced fluid control device of claim 1, wherein at least one said fluid cartridge channel is disposed to provide gas flow from at least one opening to a main chamber formed by said sample delivery element sealably coupled to said fluid cartridge.
